(19) United States
(12) Patent Application Publication
(10) Pub. No.: US 2018/0206593 A1
(43) Pub. Date: Jul. 26, 2018

(54) TRACTION ENHANCING COMPOSITION

(71) Applicant: Sean Patrick, Sudbury (CA)

(72) Inventor: Sean Patrick, Sudbury (CA)

(21) Appl. No.: 15/393,250

(22) Filed: Dec. 29, 2016

(51) Int. Cl. A43B 13/22; A43B 13/04; A43B 13/14; C09K 3/14

(52) U.S. Cl. CPC A43B 13/22; C09K 3/149; A43B 13/141; A43B 13/04

(57) ABSTRACT

An Traction enhancing solution that increases traction on all types of footwear on both dry surfaces and wet surfaces. Within a solution suitable for application to the surface of any footwear sole in liquid form, by pouring the solution into the bag supplied, and then placing the footwear into the solution for up to 12 hours. During this time, a nano-technology coating is bonded to the footwear sole that increases the traction properties of all footwear-on both dry and wet surfaces. When pressure is applied to the treated footwear—increased traction is achieved on all surfaces. Once applied to the footwear, the coating causes the surface of the footwear sole to repel debris. This imparts continued tackiness over extended use, from 1 month to up to 3 months depending on amount of use and friction the footwear sole experiences.

### BACKGROUND

The invention generally relates to increasing traction on all types of footwear and, golf club grips, motorcycle seats, snow machines, water vehicles, surfboards, work tools and more. The invention provides a significantly higher traction after treatment to the above mentioned items.

Annual shoe sales revenue was over 68 Billion in 2014. There are literally millions of makes, models and styles of footwear that are slippery and contribute to slips and falls. There are many thousands of indoor and outdoor surfaces and environments that exist where safety is improved with the availability or a surface coating that is applied to the sole of all footwear to improve traction and grip on all indoor and outdoor surfaces. A typical application is for the sole of all shoes, boots, dress shoes, high heel and all other footwear. Other surfaces which typically become slippery and un-safe when cold or wet include surgical gloves, snow machine seats, water sport seats, boards, flooring, shower surfaces, mainly shower stall floors, bathroom floors, manufacturing industries, there being a substantial need over a very wide range of applications for coatings which exhibit substantial traction or friction when said surfaces become cold or wet. Other areas that are unsafe include entrances I exits to brick and mortar businesses, swimming pools, boat decks and docks which increase safety through the supply of a traction coating which is powerful when surfaces become slipper by means of water and a drop in temperatures. All industries and people have a major safety problem at work and home with the concerns of slip & fall injuries.

Wet or damp floors are only one of the causes of slip and fall accidents within many industries. Clutter, footwear and improper cleaning also cause slip and falls or both employees and building occupants.

Slips, trips and falls make up the majority of general industry accidents. According to the U.S. Department of Labor's Occupational Safety & Health Administration (OSHA), slips, trips and falls account for 15 percent of all accidental deaths, and are second only to motor vehicles as a cause of fatalities.

Slip-Falls account for over 300,000 disabling injuries per year in North America. Worker's Compensation and Liability Insurance Rates are increasing on the average of 30% per year.

Despite greater awareness of workplace health and safety and a growing concern worldwide, these statistics show a shocking rise in workplace injuries and fatalities in the US. All industries have many hazardous conditions that lead to slip and fall injury. Such as when walking through wet areas, stairs or while using ladders. Smooth hard surfaces are also slippery when dry. Dust on all floors, ladders, stairs and other surfaces cause slip & fall accidents

### BRIEF SUMMARY OF THE INVENTION

The present invention includes a composition for providing increased grip and traction to all types' footwear. The present invention solves the slip and fall problem on all types of work boots, shoes, dress shoes, children's shoes, high heels, boots, running and athletic shoes, hiker boots, and all other footwear saving the legal risk and financial loss of companies and increased safety for everyone—no matter where they walk.

The present invention relates to a composition and, more particularly, to a traction enhancing solution. Slips and falls happen all over world, in all areas inside and outside. Currently there are anti slip products like paint with plastic particles that take 24 hours to dry. No one wants to paint their shoes, boots, high heels or paint their indoor stair cases. As can be seen, there is a need for a composition that enhances grip of surfaces and shoes.

Currently there are specialized work shoes & boots that have been designed and promoted as offering increased grip and traction in the restaurant industry and others. These do offer more grip than regular boots and shoes, but fail to provide adequate traction in all indoor and outdoor surfaces because they are made of rubber and rubber becomes slippery went wet or on cold surfaces.

The present invention allows individuals to apply a traction enhancing solution on all footwear and stair cases to avoid slips and falls. The present invention is and invisible traction enhancing solution that is odorless, colorless and takes anywhere from 1 hour to 12 hours to increase traction to any footwear by: (1.) Adding millions of nano-technology spikes to the user's footwear sole and (2.) Eliminate the need or expense of searching and buying expensive footwear that claim to be anti-slip. The invention includes enough solution to treat 46+ sets of all boots, shoes or heels

Each user must remove the bag from the package. The user then shakes the bottle and removes the cap. They then pour ½″ of the solution into the bag and then place their desired pair of footwear into the bag

The user will then wait for the prescribed time of 12 hours before they can remove their footwear. Once the time is up the user will remove their footwear and then run water over the soles of the footwear for a few seconds. The user is now complete and their footwear has added tractions on all wet and dry surfaces both indoors and outdoors.

### BRIEF DESCRIPTION OF THE DRAWINGS

The attached drawings illustrate:

FIG. 1:

You must first remove the bag from the package. The user then shakes the bottle and removes the cap. They then pour ¼″ of the solution into the bag and then place their desired pair of footwear into the bag.

FIG. 2:

Clean sole of desired footwear, and set into the bag and leave in the solution for 12 hours or overnight.

FIG. 3:

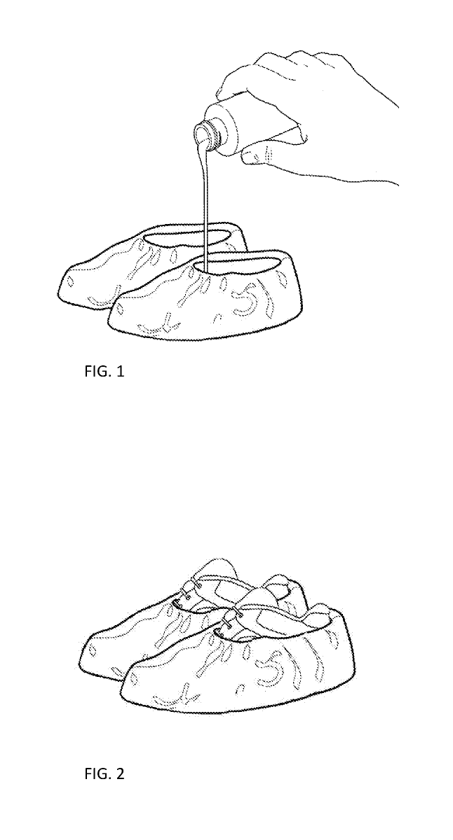

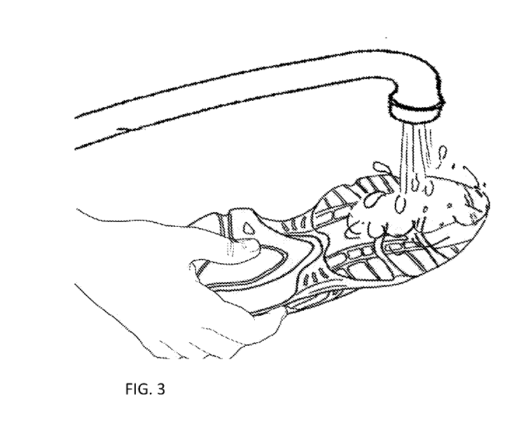

Remove footwear from bag and run under water for 3 seconds to deactivate product. You now remove footwear from bag and run under water for 3 seconds to deactivate product. You now complete and have added traction to your footwear.

1. A composition for imparting slip resistance traction to the sole of all footwear configured to substantially increase traction of all surfaces engaged by the sole of the footwear on wet and dry surfaces. A solution capable of creating millions of nano-technology spikes to the sole of footwear, adhesive and tackifier for applying a coating to a footwear sole surface and causing same to bond into a microscopic film having much greater traction than the un-treated footwear. The coating produced exhibits a tacky property when exposed to significant shear forces, wherein said composition of claim 1 which, when formed onto the surface of a footwear sole, produces a footwear sole surface that exhibits increased traction when user walks on surface that is wet or cold. Coating is flexible and bends with footwear sole and comprising of:
a film former
a microscopic coating;
a tackifier;

2. A footwear according to claim 1, wherein the sole is flexible.

3. A composition for imparting tackiness to a footwear sole surface as defined in claim 1, wherein said microscopic coating is that a polymer material.

4. A composition for imparting tackiness to a footwear sole surface as defined in claim 1, wherein said coating former comprises of sulfates that bond polymer to footwear sole.

5. A composition for imparting tackiness to a footwear sole surface as defined in claim 1, wherein the shoe sole is made of a predetermined material, and said microscopic coating is selected to adhere itself and said tackifier to said predetermined material.

6. A composition for imparting tackiness to a footwear sole surface as defined in claim 2, wherein said microscopic coating comprises a polymer selected from a group consisting of synthetic polymers and natural polymers, hydrochloric acid, alkaline and sodium resins.

7. A composition for imparting tackiness to a footwear sole surface as defined in claim 1, wherein said composition comprises a solution of greater than 85% solvent, 3-10% film former, and the remaining 2-5% said tackifier.

8. A composition for imparting tackiness to a footwear sole surface as defined in claim 1, wherein said microscopic coating is selected from a group consisting of a esters, ethers, ketones (acetone), alcohols (isopropyl alcohol) and natural ester/alcohol mixtures.

9. A composition for imparting tackiness to a footwear sole surface as defined in claim 1, further comprising nano-sized particles comprising organic emulsion polymerized cross-linked polymers.

10. A method of applying a coating on a surface to exhibit initial and continued tacky properties comprising the steps of dissolving into a solution a film former, an adhesive and a tackifier in a solvent, delivering the mixture to the surface while the mixture is in the form of a fluid composition; and allowing the solvent to evaporate to leave a layer on the surface to which the composition is applied that exhibits tacky properties when exposed to significant shear forces.

11. A method as described in claim 10, further comprising the step of adding nano-sized particles comprising organic emulsion polymerized cross-linked polymer that serve as impact modifiers for selectively softening said composition and rendering said layer microscopic coating.
